(19) United States
(12) Patent Application Publication
(10) Pub. No.: US 2005/0166798 A1
(43) Pub. Date: Aug. 4, 2005

(54) Black pigment compositions

(76) Inventor: Fridolin Babler, Teresopolis RJ (BR)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/508,712

(22) PCT Filed: Mar. 18, 2003
(86) PCT No.: PCT/EP03/02799

Related U.S. Application Data
(60) Provisional application No. 60/367,180, filed on Mar. 25, 2002.

(51) Int. Cl. C08K 5/34

(52) U.S. Cl. 106/413; 524/88

(57) ABSTRACT

The invention relates to black pigment compositions comprising green phthalocyanines, especially C.I. Pigment Green 7, and at least one second, preferably organic pigment that are subject to a co-milling process. The inventive black pigment compositions are useful for coloring high molecular weight material, like coatings, inks and plastics, especially in combination with effect pigments.

The present invention relates to new black pigment compositions and a method of using the black compositions to color various substrates, such as high molecular weight material.

Carbon black is used in large quantities for the coloration and pigmentation of many substrates due to its strong color and relatively low cost. Carbon black can be produced by a number of different processes, such as, for example, furnace black-, channel black-, gas black- or other thermal oxidative processes.

Such carbon black products are often tailor made for specific applications like plastics, automotive solvent or waterborne based paints or inks. These products can be lacking in ease of dispersibility or fail to exhibit good Theological behavior. Furthermore, these products show a strong absorption in the near IR region. Thus, articles colored by carbon black heat up quickly when exposed to sunlight, which is particularly problematic when used in car upholstery.

Another major drawback of carbon black is its color characteristic when used in different concentration or in particular in combination with other organic, inorganic or effect pigments. Carbon black often tends to shift to an undesirable brownish hue. Thus, its use for certain color styling is limited.

Black organic pigments are known. For example, German Patent No. 2,451,780 describes N-substituted perylene tetracarboxylic acid diimides as black pigments for paints, plastics and inks.

Many patents also describe the use of pigment mixtures for the creation of black colorations. For example, U.S. Pat. No. 6,235,106 describes blue shade black pigment compositions useful in paints, inks and plastics, comprising a mixture of iron oxide, chromium oxide and manganese oxide. The iron oxide primarily contains yellow iron oxide while the manganese oxide contributes to the strength and blueness of the pigment.

Published Japanese Patent No. 04-065,279 A2 describes lightfast black ink ribbons that are prepared from inks containing multiple light-resistant organic pigments. One such ink contained C.I. Pigment Yellow 123, C.I. Pigment Red 88, and C.I. Pigment Blue 15:6.

Published Japanese Patent No. 01-074,277 describes a method of toning carbon black containing inks to reduce their reddish tint by mixing them with Cu phthalocyanine pigments obtained by treating phthalic acid and/or its derivatives, urea, and Cu or its compounds in organic solvents in the presence of catalysts and berizophenone-3,3′,4,4′-tetracarboxylic acid (I), its anhydride, or imides.

Published Japanese Patent No. 10-1 04,599A describes a method for coloring resin compositions for forming shading film for liquid crystal displays—consisting of a combination of organic pigments having the color yellow, blue and purple or the combination of organic pigments with yellow, red and blue color.

U.S. Pat. No. 5,546,998 describes colorant compositions containing at least two of 1) a red pigment, 2) an orange pigment, 3) a yellow pigment, 4) a green pigment, 5) a blue pigment and 6) a violet pigment. Each of the pigments must exhibit a particular reflectance. The colorant composition is described as being achromatic black formed by additive mixing. An additive mixture of Pigment Green 7, Pigment Yellow 154 and Pigment Violet 19 is exemplified in Table 1. The patent does not disclose or suggest co-milling the pigments to produce a new pigmentary form.

Published European Patent Application 1,029,650 describes colored polyester molding material that contains a combination of yellow and violet pigments to give a black appearance, but is transparent to laser light.

U.S. Pat. No. 6,010,567 describes black-pigmented structured high molecular weight material for black matrix for optical color filter. The invention relates to a black-pigmented high molecular weight organic material, which is structured from a radiation-sensitive precursor by irradiation. The pigmentation consists of colored organic pigments, at least one of which is in latent form before irradiation. The patent does not describe co-milling of organic pigments.

European Patent Application No. 23,318 describes gray to black colored thermoplastics film for laminated identity card, containing white pigment and/or filler and gray mixture of colored organic pigments. The film is specified for the production of laminates for identity, checks or credit cards. It has an inconspicuous appearance and strong covering power, making it especially useful for purposes where forgery needs to be made difficult, but is easily detected. Preferred materials are (A) Sb oxide, kaolin, silica, chalk, Ba sulphate, Ti dioxide and ZnS; (B) mixtures of red and green pigments in 6-12:10 weight ratio; violet and green in 5-15:10 weight ratio; and violet, yellow and blue in 20:30:10 to 50:60:10 weight ratio.

Published European Patent Application No. 42,816 describes the preparation of pigment alloys by co-milling pigments from different pigment classes using a wet milling process. The application does not discuss or describe the use of C.I. Pigment Green 7 for the preparation of black pigments.

The state of the art offers various ways for the generation of black colors. However, no organic pigment compositions are described that show outstanding pigment properties for an application in a choice of substrates in particular inks, automotive paints and high performance thermoplastics.

Surprisingly, it was found that black pigment compositions could be generated, which show a unique color characteristic by co-milling mixtures of green halogenated phthalocyanine pigments with selected secondary pigments of colour different from green. The secondary pigments are selected based upon their reflectance characteristics. In particular, the desired secondary pigment, when incorporated into a 1 mm thick PVC plate at 0.1 % together with 5.0% of C.I. Pigment White 6, both by weight based on the PVC (2% tint formulation), has a spectral curve with a reflectance of above 50%, preferably above 60%, in the range of about 500 to 700 nm as measured by a spectrophotometer. Examples of spectral curves and suitable pigments can be found from the qualitative color description in the NPIRI Raw Materials Data Handbook, Volume 4 Pigments edited by the National Printing Ink Research Institute, Lehigh University, Bethlehem, Pa. 18015, USA. A useful Pigment White 6 is for example ®KRONOS CL 2310 (Kronos International Inc.); the PVC platelets can be made according to DIN 53775/part 2.

Hence, the invention pertains to a black pigment composition comprising from 2 to 98, preferably from 5 to 95, most preferred from 10 to 90 parts by weight of a green halogenated phthalocyanine pigment and from 2 to 98, preferably from 5 to 95, most preferred from 10 to 90 parts by weight of a second pigment that is not a green pigment and, when incorporated into a 1 mm thick PVC plate at 0.1 % together with 5.0% of C.I. Pigment White 6, both by weight based on the PVC, has a reflectance of above 50%, preferably above 60%, in the range of from 500 to 700 nm, wherein the parts by weight of the green pigment and the second pigment total 100 parts by weight, which pigment composition has a specific surface area below 50 m²/g.

The second pigment is preferably organic and may be a single pigment or a mixture of two or more, for example from 2 to 5 pigments. In the case of a second pigment which is a mixture, the reflectance should suitably be above 50%, preferably above 60%, in the range of 500 to 700 nm, as for a single second pigment. It is not necessary that each pigment of such mixture has such a reflectance when measured alone; however, mixtures preferably comprise at least 50% by weight of one or more pigments which have a reflectance above 50%, preferably above 60%, in the range of 500 to 700 nm when measured alone.

Green halogenated phthalocyanine pigments are for example chlorinated copper phthalocyanine (C.I. Pigment Green 7 or 37) or brominated or mixed chlorinated/brominated copper phthalocyanine (C.I. Pigment Green 36).

Particularly interesting black pigment compositions can be obtained by co-milling mixtures of C.I. Pigment Green 7 with quinacridone magenta-, with red to orange diketopyrrolo pyrrole-, with red to maroon perylene- or yellow isoindolinone pigments or their mixtures thereof. Such products show outstanding pigment properties and due to their unique color offer new styling opportunities.

Thus, the present invention relates to a process for the preparation of new strongly black pigment compositions, which offer the possibility of the creation of new color shades when applied in mixture with other pigments, for example effect pigments.

Suitable organic pigments which fall into the inventive color range are for example pigments of the azo, azomethine, methine, anthraquinone, dioxazine, phthalocyanine, perinone, perylene, diketopyrrolo pyrrole, thioindigo, iminoisoindoline, iminoisoindolinone, quinacridone, flavanthrone, indanthrone, anthrapyrimidine and quinophthalone pigment classes; in particular of the diketopyrrolopyrrole, quinacridone, anthraquinone, perylene, iminoisoindoline or iminoisoindolinone pigment classes, and mixtures thereof.

Preferred organic pigments that may be used in combination with green halogenated phthalocyanine pigments are, for example, C.I. Pigment Violet 19, C.I. Pigment Red 254, C.I. Pigment Red 202, C.I. Pigment Red 122, C.I. Pigment Red 179, C.I. Pigment Red 220, C. I. Pigment Red 264, C.I. Pigment Red 177, C.I. Pigment Red 255, C.I. Pigment Orange 61, C.I. Pigment Orange 64, C.I. Pigment Orange 73, C.I. Pigment Orange 48, C.I. Pigment Orange 49, C.I. Pigment Yellow 110 or C.I. Pigment Yellow 147.

Highly preferred organic pigments are for example the quinacridone pigments C.I. Pigment Red 202 and C.I. Pigment Red 122, the diketopyrrolo pyrrole pigments C.I. Pigment Red 254, C.I. Pigment Red 255 and C.I. Pigment Red 264, the perylene pigment C.I. Pigment Red 1 79 and the iminoisoindolinone pigment C.I. Pigment Yellow 110. Each of these pigments exhibits the desired spectral curve characteristics.

New black pigments can be generated when co-milling green halogenated copper phthalocyanines with the above-mentioned organic pigments. Depending on the kind of second pigment and the kind and especially ratio of the green halogenated copper phthalocyanines to second pigment, such black pigment compositions show an attractive strong black mass tone color. In comparison to common black pigments such as carbon black, surprisingly, the inventive black pigments show different chromatic hues when applied in conjunction with other organic, inorganic or effect pigments as more explicitly described in the patent examples. As illustrated in the accompanying examples, a masstone formulation generally produces a strong black coating, while combined with a metallic dispersion containing aluminium paste, or with a pearlescent pigment dispersion surprisingly different shades such as for example green, blue or magenta are generated. Thus, unexpectedly such black pigments are ideal adjunct-effect pigments and therefore beneficial for shading applications.

Typically, the ratio of the green halogenated copper phthalocyanine to the second pigment is in the range of 2 to 98 percent green halogenated copper phthalocyanine and 2 to 98 percent by weight second pigment, preferably 5 to 95 percent green halogenated copper phthalocyanines to 5 to 95 percent second pigment and most preferably 10 to 90 percent green halogenated copper phthalocyanine to 10 to 90 percent second pigment or mixture of second pigments according to this invention.

The preparation of the green halogenated copper phthalocyanines such as for example C.I. Pigment Green 7, the chlorinated copper phthalocyanine is well known in the industry and several pigment producers market it. A particular interesting form for the current invention is ®IRGALITE Green GLPO, a small particle size C.I. Pigment Green 7 with average pigment particle size of below 0.2 μm (Ciba Specialty Chemicals Inc.).

The inventive pigment mixtures can be dry co-milled in known equipments like ball mills or attritor or high speed mixers known in the industry with or without milling aids like salt and/or surfactants.

Preferably the inventive pigment mixtures are wet—milled in a solvent media or preferably by an aqueous milling process without or rather with additives. The milling apparatus may be any suitable device, which makes it possible for the pigment mixture to be subjected to mechanical forces. For example, a suitable milling process includes one wherein a grinding element, such as metal, glass, porcelain or zirconium oxide balls, plastic granules or sand grains, is set in motion by rotation, or vibration. Milling media of any usual granulometry can be used, for example such of average size from 0.1 to 100 mm, depending on the device to be used. Devices such as kneaders or horizontal or vertical bead mills are also suitable as apparatus for the milling process. Horizontal bead mills that allow a continuous flow of an aqueous pigment suspension through the mill are particularly useful milling equipments.

When co-milled in an aqueous phase, the starting pigments can be in powder or aqueous presscake form. They can be pigment crude or preferably small particle size direct pigmentary products or finished pigments. Preferably, C.I. Pigment Green 7 is used in a high solid presscake form with a solid content of above 40 percent.

Preferably the aqueous co-milling process is carried out at a temperature of 20 to 90° C., preferably 30 to 60° C. and at a pH in the range of 4 to 8, preferably 6 to 8.

The mill is run for 1 to 72 hours, preferably 6 to 24 hours. The milling time for achieving the pigment in the desirable black form depends on the size and kind of the mill, the milling media, the rotation speed or vibration energy applied as well as the kind of additives present and pigment concentration in the milling suspension.

Preferably, wet-milling is used whereby the pigment concentration is 10 to 40 percent, preferably 13 to 20 percent by weight, based on the total weight of the milling suspension.

In order to further improve the properties of the inventive pigments obtained by the present process texture-improving agents, which can also act as milling auxiliaries, anti-flocculating agents or extenders are optionally added before, during or after the milling process.

The texture-improving agent, anti-flocculant and/or extender is preferably incorporated into the present black pigment in an amount of from 0.05 to 30 percent, most preferably 0.5 to 25 percent, by weight, based on the combined weights of the pigment mixture.

Texture-improving agents are especially useful as an additional component, which improves the properties of the black pigment composition. Suitable texture-improving agents include fatty acids having at least 12 carbon atoms, and amides, esters or salts of fatty acids. Typical fatty acid derived texture-improving agents include fatty acids such as stearic acid or behenic acid, and fatty amines like lauryl amine, or stearylamine. In addition, fatty alcohols or ethoxylated fatty alcohols, polyols, like aliphatic 1,2-diols or polyvinylalcohol and epoxidized soy bean oil, waxes, resin acids and resin acid salts are suitable texture-improving agents. Rosin acids and rosin acid salts are especially suitable texture-improving agents.

Preferably the aqueous co-milling process is carried out in the presence of milling auxiliaries like anionic-, cationic- and nonionic-surface active agents such as for example the sulfonated oils, alkylaryl sulfonates, sulfated alcohols, quaternary ammonium salts of aliphatic- or alkylaryl amines or N-hetero cyclic compounds, inorganic fillers like talc, ethoxylated fatty alcohols or polymers such as for example micronized waxes, poly acrylate, polyvinyl methyl ether, polyvinyl pyrrolidone or copolymers thereof.

Particularly good results were achieved when the co-milling is carried out in the presence of a dispersion of a water-insoluble or only partially water-soluble high molecular weight alcohol ethoxylate or a water-soluble polyvinyl pyrrolidone of a molecular weight of between 5,000 and 200,000, preferably between 10,000 and 100,000.

Anti-flocculating agents, which can also act as rheology improving agents are known in the pigment industry as for example a copper phthalocyanine derivative, a quinacridone- or a dihydroquinacridone derivative.

Although it is possible and mentioned in the above state of the art that black pigments can be obtained by simply mixing appropriate pigments, the inventive black pigment compositions differ in that they are co-milled, thus, mixed up in a much more homogeneous way. For example, the X-ray diffraction pattern of the inventive co-milled pigments differs from the corresponding pigment mixtures in that it has a very low crystallinity in which the characteristic peaks of the individual pigments are not visual anymore. In essence, the co-milling process produces a black pigment composition in which the X-ray diffraction of the resulting pigment does not correspond to the X-ray diffraction of either of the individual pigments or to the sum of patterns.

Furthermore the inventive co-milled pigment mixtures show a darker hue versus the corresponding pigment mixture. Thus, they show a lower chroma.

Generally, the inventive black pigment composition is characterized by having a chroma C* as measured by C.I.E.-L*C*h 1976 color space values in masstone of less than 3, preferably less than 2.8 as measured on a panel coated with an acrylic or polyester enamel coating of dry film thickness of 35±10 μm and pigment to binder ratio of 0.5 by weight.

By co-milling the inventive pigment mixture, the pigment particles are hammered together to alloy like aggregates having plate-like particle shape of the size of from 0.1 to 3.5 μm, preferably an average particle size of from 0.2 to 2 μm.

The specific surface area of such aggregated black pigment compositions according to this invention is from 3 to 50 m²/g. Most preferably, the specific surface area is above 4 m²/g, especially in the range of from 5 to 35 m²/g, as measured by the BET method.

Thus, unexpectedly, by co-milling the inventive pigment mixtures new black pigment compositions are generated having specific pigment properties, for example displaying an unambiguous X-ray diffraction pattern and showing unique color characteristic when applied in high molecular weight substrates.

Typically, the inventive black pigment composition is prepared in any suitable equipment like a ball mill containing stainless steel shots or ceramic media by adding water, the pigments, optionally an additive, milling the mixture preferably at from 30 to 60° C. and pH 6 to 8 for 2 to 24 hours, separating the suspension from the milling media and, isolating the resulting black pigment composition by filtration, washing and drying.

Thus, the invention also pertains to a method for preparing a black pigment composition comprising
a) forming a mixture by combining water; a green halogenated phthalocyanine pigment; at least one other pigment which has a reflectance of above 50% when incorporated into a 1 mm thick PVC plate at 0.1% together with 5.0% of C.I. Pigment White 6, both by weight based on the PVC, and subjected to light waves in the range of 500 to 700 nm; and optionally an additive;
b) wet-milling the mixture in a mill containing milling media, preferably at a temperature 30 to 60° C. and pH 6 to 8, for 2 to 24 hours, so as to form a suspension;
c) separating the suspension from the milling media; and
d) isolating a black co-milled pigment composition by filtration, washing and drying.

The black pigment compositions of this invention are suitable for use as pigments for coloring high molecular weight organic material, for example in an amount of from 0.001 to 70% by weight, based on the weight of the high molecular weight organic material.

Examples of substrates (usually organic materials of weight average molecular weight M_{w} from 10⁴ to 10⁸) which may be colored or pigmented with the inventive black pigment compositions are cellulose ethers and esters such as ethyl cellulose, nitrocellulose, cellulose acetate, cellulose butyrate, natural resins or synthetic resins such as polymerization resins or condensation resins, for example aminoplasts, in particular urea/formaldehyde and melamine/formaldehyde resins, alkyd resins, phenolic plastics, polycarbonates, polyolefins, polystyrene, polyvinyl chloride, polyamides, polyurethanes, polyesters, rubber, casein, silicone and silicone resins, singly or in mixtures.

The above high molecular weight organic materials may be singly or as mixtures in the form of plastics, melts or of spinning solutions, varnishes, paints or printing inks. The inventive black pigment compositions are preferably employed in an amount of 0.1 to 30 percent by weight, based on the high molecular organic material to be pigmented.

The pigmenting of the high molecular weight organic materials with the black pigment compositions of the invention is carried out for example by incorporating such a composition, optionally in the form of a masterbatch, into the substrates using roll mills, mixing or grinding machines. The pigmented material is then brought into the desired final form by methods which are known per se, for example calendering, molding, extruding, coating, spinning, casting or by injection molding. It is often desirable to incorporate plastizisers into the high molecular weight compounds before processing in order to produce non-brittle moldings or to diminish their brittleness. Suitable plasticizers are for example esters of phosphoric acid, phthalic acid or sebacic acid. The plastizisers may be incorporated before or after working the composition into the polymers.

To obtain different shades, it is also possible to add inorganic or polymeric fillers or other chromophoric components such as organic or inorganic pigments like white, colored, effect, fluorescent or phosphorescent pigments, in any amount, to the high molecular weight organic compounds, in addition to the black pigment compositions of this invention.

The inventive black pigment compositions lead to particularly advantageous results when used in combination with effect pigments, for example such showing nacreous, metallic and/or goniochromatic effects, such as natural or synthetic micas, metallic flakes, and interference pigments.

Especially suitable classes of effect pigments which can be advantageously used in combination with the inventive black pigment compositions are selected from the group of metallic pigments like aluminium, gold, brass or copper pigments, including metal oxide coated metal pigments such as iron oxide coated aluminium as described in published European Patent 33457, platelike graphite or molybdenium disulfide pigments as those described in U.S. Pat. Nos. 4,51 7,320; 5,034,430; large particle size organic pigments such as those described in U.S. Pat. Nos. 5,084,573; 5,095,122; 5,298,076 and 5,347,014; the well known coated flaky mica, synthetic aluminium oxide or silicon dioxide pigments, wherein the coating can be single or multi layered consisting of colorless, chromatic or black microcrystalline compounds such as TiO₂, SnO₂, ZrO₂, FeOOH, Fe₂O₃, Cr₂O₃, CrPO₄, KFe[Fe₉CN)₆, TiO₂₋ₓ, Fe₃O₄, FeTiO₃ TiN and TiO, and the more recent classes of effect pigments, for example, the multilayer interference platelets disclosed in PCT International Applications WO 95-17,480 and WO 95-29,140, or the liquid crystal interference pigments described for example in the German patent 4,418,075.

Thus, the invention also pertains to a pigment composition, comprising from 1 to 99.9% by weight of an effect pigment and from 0.1 to 99%, preferably from 0.5 to 60%, most preferred from 1 to 30% by weight of the above-described black pigment composition, based on the total weight of effect pigment and above-described black pigment composition.

The effect pigments can be added already at the wet-milling stage; however, it is much preferable first to wet-mill the green phthalocyanine together with the pigment of different color, and then only to combine with the effect pigment at any time between wet-milling up to the final pigmentation of an object, optionally using masterbatches.

Although the new black pigment compositions show a good light and heat stability it can be advantageous to apply the present compositions in the presence of commonly known and commercially available antioxidants, UV absorbers, light stabilizers, processing agents and so forth.

For pigmenting coatings, varnishes and printing inks, the high molecular weight organic materials and the inventive pigmentary compositions, together with optional additives such as fillers, other pigments, siccatives, light- or UV-stabilizers, are finely dispersed in a common organic solvent or mixture of solvents including water. The procedure may be such that the individual components by themselves, or also several jointly, are dispersed or dissolved in the solvent and subsequently all the components are mixed.

The inventive black pigment compositions have good Theological properties, and are particularly suitable for preparing aqueous and solvent based coatings conventionally employed in the automobile industry, especially in acrylic/melamine resin, alkyd/melamine resin or thermoplastic acrylic resin systems, as well as in powder coatings and UV/EB cured coating systems.

Black pigment compositions with especially good rheological properties are achieved when C.I. Pigment Green 7 is co-milled with a substituted or unsubstituted quinacridone pigment and followed by an after treatment with 2 to 10 percent based on the pigment mixture of quinacridone mono sulfonic acid and/or quinacridone mono sulfonic acid aluminium salt and/or 3,5-dimethyl pyrazol-1-methyl quinacridone. In comparison to carbon black, such black co-milled pigment mixtures show considerably better Theological properties when applied in automotive and industrial paints.

Coatings and ink systems colored with the inventive black pigment compositions possess a high gloss, excellent heat, light and weather fastness, as well as bleed and over spraying fastness properties.

Due to their outstanding heat stability, the inventive black pigment compositions are particularly appropriate for coloring thermoplastics including polypropylene, polyethylene, soft, medium hard and hard polyvinyl chloride, ABS, PES and nylon. For example in soft and medium hard polyvinyl chloride very attractive, black, migration resistant coloration's can be generated.

The colorations obtained show unique reflection spectra and for example in plastics, filaments, have good all-round fastness properties such as high migration resistance, heat and light stability and weathering behavior.

Generally, the inventive black pigment compositions show reflection of 4 to 7 percent, preferably 4 to 6 percent in the region of 400 to 700 nm, when applied at a pigment concentration of 0.5 percent in high-density polyethylene and molded at 200° C.

The black pigment compositions of this invention are also suitable for use as colorants for paper, leather, inorganic materials, seeds, and in cosmetics.

The following examples illustrate various embodiments of the invention, but the scope of the invention is not limited thereto. In the examples, all parts are by weight unless otherwise indicated. The X-ray diffraction patterns are measured on a RIGAKU GEIGERFLEX diffractometer, type D/MaxII v BX. The coloristic data are obtained utilizing a CS-S CHROMA SENSOR spectrophotometer and the electron micrograph taken on a Zeiss type 910 electron microscope.

### EXAMPLE 1

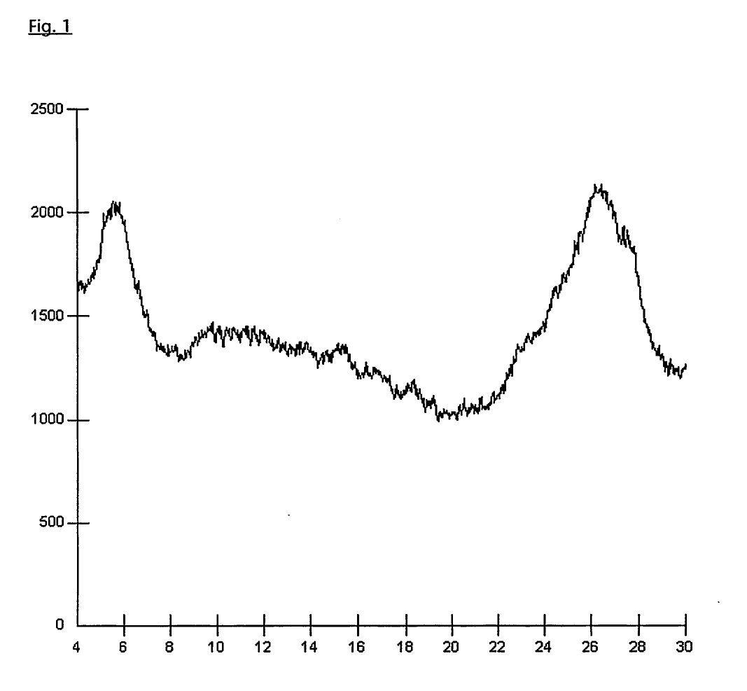

A 500 ml flask is charged with 1400 g stainless steel beads with an average diameter of 3 mm, 45.2 g aqueous presscake of C.I. Pigment Green 7 (®IRGALITE Green GLPO, Ciba Specialty Chemicals Inc.), having a solid content of 48.7% by weight, 4.4 g C.[. Pigment Red 202 (®CINQUASIA Magenta RT-235-D, Ciba Specialty Chemicals Inc.), 3.5 g ®Luviskol K-30, a 30% aqueous solution of polyvinyl pyrrolidone (BASF) and 1 30 ml water. The flask is closed tight and its contents are milled for 18 hours by rolling the flask on a rolling gear at a rotation speed of 35 m/minute. The black pigment suspension is separated from the steel beads, filtered and the presscake is washed with water and dried. The dried pigment is pulverized. The X-ray diffraction pattern (FIG. 1=scatteringangle versus relative intensity in counts) shows mainly two broad peaks with the following data:

| Scattering angle | Relative intensity |
|---|---|
| [° 2θ] | [%] |
| 5.5 | 97 |
| 26.3 | 100 |

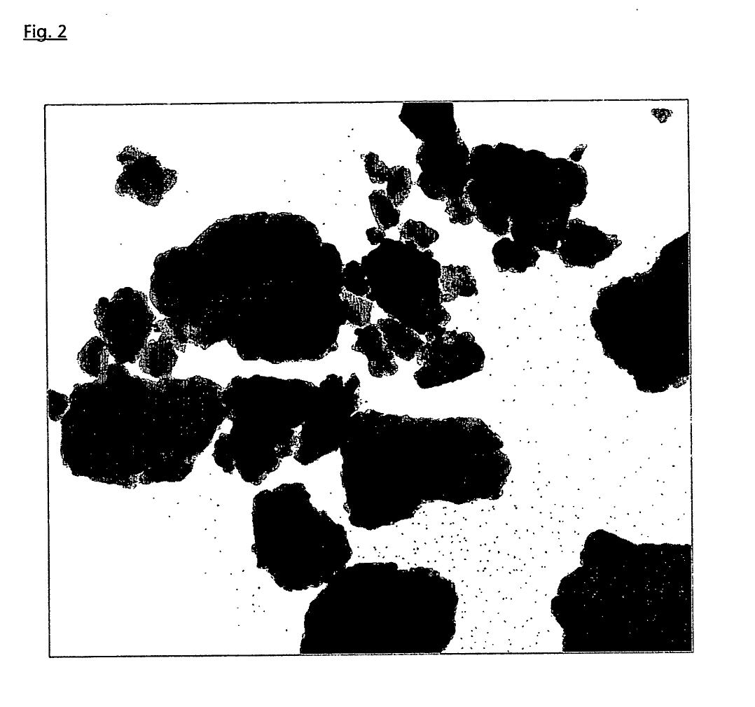

The electron micrograph (FIG. 2: 20000> magnification/detail 5.6×4.9 μm) shows many plate-like aggregated particles with a particle size mainly in the range of 0.3 to 3.0 μm. The specific surface area of the black pigment composition is 19 m²/g as measured by the BET method. By rubout according to ASTM method D-387-60 in a lithographic varnish, the pigmentary composition shows a strong black mass tone color and surprisingly a greenish blue tinting color.

### EXAMPLE 2

The procedure of Example 1 is repeated, however using additionally 1.4 g of C.I. Pigment Yellow 110 (®CROMOPHTAL Yellow 3RT, Ciba Specialty Chemicals Inc.), as a third pigment component. A strong black pigment is generated with equally good pigment properties. The specific surface area of the black pigment composition is 11.9 m²/g, as measured by the BET method.

### EXAMPLE 3

A 500 ml flask is charged with 1400 g stainless steel beads with an average diameter of 3 mm, 28.7 g aqueous presscake of C.I. Pigment Green 7 having a solid content of 48.7% by weight, 14 g C.I. Pigment Red 202, 2 g ®Luviskol K-30. The flask is closed tight and its contents are milled for 18 hours by rolling the flask on a rolling gear at a rotation speed of 35 m/minute. The black pigment suspension is separated from the steel beads, filtered and the presscake is washed with water and dried. The dried pigment is pulverized. By rubout according to ASTM method D-387-60 in a lithographic varnish, the pigmentary composition shows a strong black mass tone color and surprisingly a bluish tinting color.

### EXAMPLE 4

The procedure of Example 3 is repeated, using instead of 28.7 g 20.5 g aqueous presscake of C.I. Pigment Green 7 having a solid content of 48.7% and instead of 14 g 18 g C.I. Pigment Red 202, and instead of drying the pigment presscake, reslurrying it in water in the presence of 2.2 g of a 1:1 mixture of quinacridone mono sulfonic acid aluminium salt and 3,5-dimethyl pyrazol-1 -methyl quinacridone followed by filtration and drying. By rubout according to ASTM method D-387-60 in a lithographic varnish, the pigmentary composition shows a strong black mass tone color and surprisingly a bluish red tinting color. When incorporated in an automotive paint such a pigment shows excellent rheological properties with a dark black hue and outstanding weatherability behavior.

### EXAMPLE 5

A 500 ml flask is charged with 1400 g stainless steel beads with an average diameter of 3 mm, 43 g aqueous presscake of C.I. Pigment Green 7 having a solid content of 48.7% by weight, 5 g C.I. Pigment Yellow 110, 2 grams ®Luviskol K-30r. The flask is closed tight and its contents are milled for 18 hours by rolling the flask on a rolling gear at a rotation speed of 35 m/minute. The black pigment suspension is separated from the steel beads, filtered and the presscake is washed with water and dried. The dried pigment is pulverized. By rubout according to ASTM method D-387-60 in a lithographic varnish, the pigmentary composition shows a strong black mass tone color and surprisingly a greenish tinting color.

### EXAMPLE 6

The procedure of Example 5 is repeated, using instead of 5 g C.I. Pigment Yellow 110, 5 g C.I. Pigment Red 179 (®PALIOGEN Red L 3885, a perylene pigment from BAYER), yielding a black pigment with equally good pigment properties. By rubout according to ASTM method D-387-60 in a lithographic varnish, the pigmentary composition shows a strong black mass tone color and a gray tinting color.

### EXAMPLE 7

The procedure of Example 1 is repeated, using instead of 3.5 g ®Luviskol K-30 8 g ®Petrolite D-1038 Dispersion, a 10% solids dispersion of a high molecular weight alcohol ethoxylate (Baker Petrolite Polymers Division, Sugarland Tex., USA), yielding a black pigment with excellent pigment properties.

### EXAMPLE 8

The procedure of Example 5 is repeated, using instead of 5 g C.I. Pigment Yellow 110 5 g C.I. Pigment Red 254 (®IRGAZIN DPP Red BO, a diketopyrrolo pyrrole pigment from Ciba Specialty Chemicals Inc.), yielding a black pigment with equally good pigment properties. By rubout according to ASTM method D-387-60 in a lithographic varnish, the pigmentary composition shows a strong black mass tone color and a gray tinting color.

### EXAMPLE 9

The procedure of Example 5 is repeated using instead of 5 g C.I. Pigment Yellow 110 5 g C.I. Pigment Red 264 (®IRGAZIN DPP Rubine TR, another diketopyrrolo pyrrole pigment from Ciba Specialty Chemicals Inc.), yielding a black pigment with equally good pigment properties. By rubout according to ASTM method D-387-60 in a lithographic varnish, the pigmentary composition shows a strong black mass tone color and a gray tinting color.

### EXAMPLE 10

The procedure of Example 5 is repeated using instead of 5 g Pigment Yellow 110 5 g C.I. Pigment Red 122 (®CROMOPHTAL Pink PT, a quinacridone pigment from Ciba Specialty Chemicals Inc.), yielding a black pigment with equally good pigment properties. By rubout according to ASTM method D-387-60 in a lithographic varnish, the pigmentary composition shows a strong black mass tone color and surprisingly a greenish gray tinting color.

### EXAMPLE 11

The procedure of Example 5 is repeated using instead of 5 g Pigment Yellow 110 5 g C.I. Pigment Red 220 (®CROMOPHTAL Red G, an azo pigment from Ciba Specialty Chemicals Inc.), yielding a black pigment with equally good pigment properties. By rubout according to ASTM method D-387-60 in a lithographic varnish, the pigmentary composition shows a strong black mass tone color and a gray tinting color.

### EXAMPLE 12

This example shows the incorporation of the inventive pigment black into an automotive solvent-based paint system.

Mill Base Formulation

A 473 ml jar is charged with 30.0 g high solids acrylic copolymer resin (68% by weight of solids, DUPONT), 6.55 g acrylic A-B dispersant resin (55% solids, DUPONT), and 71.45 g ®Solvesso 100 (American Chemical). 12 g black pigment composition of Example 1 and 240 g of glass beads are added. The mixture in the jar is shaken on a Skandex shaker for 4 hours. The black “mill base” contains 10.0% pigment with a pigment/binder ratio of 0.5 and a solids content of 30% by weight.

Masstone Color for Spraying a Panel

82.6 g of the above millbase, 39.7 g of a polyester acrylic urethane based solution (47.8% by weight of solids), 17.7 g of a melamine resin based solution (both solutions available from DUPONT) are mixed and diluted with a solvent mixture comprising 76 parts xylene, 21 parts butanol and 3 parts methanol to a spray viscosity of 20-22 seconds as measured by a #2 Fisher Cup. The resin/pigment dispersion is sprayed onto a panel twice at 1½ minute intervals as basecoat. After 2 minutes, the clearcoat resin is sprayed twice at 1½ minute intervals onto the basecoat. The sprayed panel is then flashed with air in a flash cabinet for 10 minutes and then “baked” in an oven at 129° C. (265° F.) for 30 minutes, yielding a black colored panel.

Metallic Dispersion

A 946 ml can is charged with 405 g aluminium paste (™5245AR, Silberline), 315 g non-aqueous dispersion resin and 180 g acrylic urethane resin and stirred for 1 to 2 hours until lump free.

Metallic Color for Spraying Panel (80/20 Al)

64.4 g above black mill base, 5.8 g above metallic dispersion, 41.8 g polyester acrylic urethane based solution and 13 g melamine based solution are mixed. The viscosity is reduced to 20-22 seconds using a N2 Fisher device by a thinning solvent mixture of the following composition: 76 g xylene, 21 g butanol and 3 g methanol. The resin/pigment dispersion is sprayed onto a panel twice at an one minute interval as basecoat. After 3 minutes, clearcoat resin is sprayed twice at an one minute interval onto the basecoat. The sprayed panel is then flashed with air in a flash cabinet for 10 minutes and then baked in an oven at 130° C. (265° F.) for 30 minutes, yielding surprisingly a metallic, green-colored panel with excellent weatherability. A microscopic evaluation shows a homogeneous distribution of the pigment particles in the coating system.

Russet Mica Dispersion

The following ingredients are stirred together to provide a mica dispersion containing 27.9% by weight of pearlescent mica pigment and a total solid content of 69.1% by weight of solids:
251.1 g of bright russet mica, (®EXTERIOR MEARLIN, The Mearl Corp.),
315.0 g of non-aqueous dispersion resin, and
180.0 g of acrylourethane resin.
   Russet Mica Color for Sraying Paint

A 50/50 russet mica shade coating (for 25% pigment loading) is prepared by mixing the following ingredients:
50.3 g of above black mill base dispersion,
14.5 g of above russet mica dispersion,
44.1 g of a polyester acrylic urethane based solution, and
15.6 g of a melamine based solution.

The black pigment/pearlescent mica/resin dispersion, which has excellent rheological properties, is sprayed onto a primed panel 8 times (for complete hiding) in 1 minute intervals as basecoat. After 3 minutes, clear coat resin is sprayed twice at 1 minute intervals onto the basecoat. The sprayed panel is flashed with air in a flash cabinet for 10 minutes and then baked in an oven at 1 30° C (265° F). A black colored effect coating with excellent weatherability is obtained. The black coating shows high gloss and a reddish flop.

Color Measurement

The following color characteristic data are measured on the coated panels demonstrating the surprising hue shifts when applied with different kind of effect pigments. C.I.E. L*, C*, h color space value numbers using a D65 illuminant and 10 degree observer with a specular component included:

| Coated panel | L* | C* | h |
|---|---|---|---|
| Mass tone | 25.8 | 2.6 | 236.7 |
| 80/20 aluminium | 46.6 | 21.3 | 190.3 |
| 50/50 russet mica | 32.4 | 2.8 | 288 |

### EXAMPLE 13

The procedure of Example 12 is repeated, using instead of the black pigment composition of Example 1, the black pigment composition of Example 3 yielding coated panels having the following color characteristics:

| Coated panel | L* | C* | h |
|---|---|---|---|
| Masstone | 25.8 | 2.5 | 282.7 |
| 80/20 aluminium | 45.1 | 13.3 | 225.4 |
| 50/50 russet mica | 30.6 | 6.0 | 312.3 |

Thus, the masstone panel is black, and surprisingly, the 80/20 aluminium panel is blue with a dark flop and the 50/50 russet mica panel is a magenta with a bluish flop.

### EXAMPLE 14

The procedure of Example 12 is repeated, using instead of the black pigment composition of Example 1, the black pigment composition of Example 4 yielding coated panels having the following color characteristics:

| Coated panel | L* | C* | h |
|---|---|---|---|
| Masstone | 25.8 | 2.7 | 293.2 |
| 80/20 aluminium | 44.2 | 12 | 257.9 |
| 50/50 russet mica | 30.8 | 8.4 | 326.2 |

Thus, the masstone panel is black, and surprisingly, the 80/20 aluminium panel is blue with a reddish flop and the 50/50 russet mica panel is a magenta with a bluish flop.

### EXAMPLE 15

The procedure of Example 12 is repeated, using instead of the black pigment composition of Example 1, the black pigment composition of Example 5 yielding coated panels having the following color characteristics:

| Coated panel | L* | C* | h |
|---|---|---|---|
| Masstone | 25.8 | 1.6 | 223.2 |
| 80/20 aluminium | 51.2 | 28.8 | 164.4 |
| 50/50 russet mica | 32.5 | 2.5 | 155.3 |

Thus, the masstone panel is black, and surprisingly, the 80/20 aluminium panel is a saturated green and the 50/50 russet mica panel is a black with a distinguished greenish yellow flop.

### EXAMPLE 16

The procedure of Example 12 is repeated, using instead of the black pigment composition of Example 1, the black pigment composition of Example 6 yielding coated panels having the following color characteristics:

| Coated panel | L* | C* | h |
|---|---|---|---|
| Masstone | 25.6 | 1.1 | 251.6 |
| 80/20 aluminium | 43.9 | 12.2 | 167.1 |
| 50/50 russet mica | 30.0 | 1.3 | 341.5 |

Thus, the masstone panel is black, and surprisingly, the 80/20 aluminium panel is green with a reddish black flop and the 50/50 russet mica panel is a black with a strong flop.

### EXAMPLE 17

63.0 grams of polyvinyl chloride, 3.0 g epoxidized soy bean oil, 2.0 g of barium/cadmium heat stabilizer, 32.0 g dioctyl phthalate and 1.0 g of the black pigment composition prepared according to Example 1 are mixed together in a glass beaker using a stirring rod. The mixture is formed into a soft PVC sheet with a thickness of about 0.4 mm by rolling for 8 minutes on a two roll laboratory mill at a temperature of 160° C., a roller speed of 25 rpm and friction of 1:1.2, by constant folding, removal and feeding. The resulting soft PVC sheet is colored in an attractive black shade and has excellent fastness to heat, light and migration.

### EXAMPLE 18

5 g of the black pigment composition prepared according to Example 3, 2.65 g ®CHIMASORB 944LD (hindered amine light stabilizer), 1.0 g ®TINUVIN 328 (benzotriazole UV absorber) and 2.0 g ®IRGANOX B-215 Blend (anti-oxidant, all additives available from Ciba Specialty Chemicals Inc.), are mixed together with 1000 g of high density polyethylene at a speed of 175-200 rpm for 30 seconds after flux. The fluxed, pigmented resin is chopped up while warm and malleable, and then fed through a granulator. The resulting granules are molded on an injection molder with a 5 minute dwell time and a 30 second cycle time at a temperature of 200, 250 and 300° C. Homogeneously colored chips, which show a black color with practically no color differences, are obtained. They have an excellent light stability. The black chips show reflection of 4 to 6 percent in the region of 400 to 700 nm.

1. A black co-milled pigment composition comprising from 2 to 98 parts by weight of a green halogenated phthalocyanine pigment and from 2 to 98 parts by weight of a second pigment which is not a green pigment and, when incorporated into a 1 mm thick PVC plate at 0.1% together with 5.0% of C.I. Pigment White 6, both by weight based on the PVC, has a reflectance of above 50% in the range of 500 to 700 nm, wherein the parts by weight of the green pigment and the second pigment total 100 parts by weight, which pigment composition has a specific surface area below 50 m²g.

2. A pigment composition according to claim 1, in which the green halogenated phthalocyanine pigment is C.I. Pigment Green 7, C.I. Pigment Green 37, C.I. Pigment Green 36 or a mixture thereof.

3. A pigment composition according to claim 1, in which the X-ray diffraction pattern of said co-milled pigment composition differs from an X-ray diffraction pattern for either of the individual pigments used to make the co-milled pigment composition.

4. A pigment composition according to claim 1, wherein the second pigment is an organic pigment selected from the class of pigments consisting of azo, azomethine, methine, anthraquinone, dioxazine, phthalocyanine, perinone, perylene, diketopyrrolo pyrrole, thioindigo, iminoisoindoline, iminoisoindolinone, quinacridone, flavanthrone, indanthrone, anthrapyrimidine and quinophthalone pigments or a mixture thereof.

5. A pigment composition according to claim 1, wherein the second pigment is selected from the group consisting of C.I. Pigment Violet 19, C.I. Pigment Red 254, C.I. Pigment Red 202, C.I. Pigment Red 122, C.I. Pigment Red 179, C.I. Pigment Red 220, C.I. Pigment Red 264, C.I. Pigment Red 177, C.I. Pigment Red 255, C.I. Pigment Orange 61, C.I. Pigment Orange 64, C.I. Pigment Orange 73, C.I. Pigment Orange 48, C.I. Pigment Orange 49, C.I. Pigment Yellow 110 and C.I. Pigment Yellow 147.

6. A pigment composition, comprising from 1 to 99.9% by weight of an effect pigment and from 0.1 to 99% by weight of a pigment composition according to claim 1, based on the total weight of effect pigment and pigment composition according to claim 1.

7. A pigment composition according to claim 3, wherein C.I. Pigment Green 7 has an average particle size of less than 0.2 μm as measured by an electron micrograph.

8. A pigment composition according to claim 1, wherein the mixture is milled in the presence of additives by a dry or wet milling process.

9. A pigment composition according to claim 8, wherein the mixture is co-milled at 30 to 60° C. and at a pH of 6 to 8 for 1 to 72 hours in an aqueous media.

10. A black pigment composition according to claim 8, wherein the mixture is wet-milled at a pigment concentration of 13 to 20% by weight, based on the total weight of the milling suspension.

11. A black pigment composition according to claim 8, wherein the mixture is milled in the presence of an additive selected from the group consisting of texture improving agents, milling auxiliaries, anti-flocculating agents, extenders and mixtures thereof.

12. A pigment composition according to claim 11, wherein the additive is added in an amount of 0.5 to 25% by weight, based on the pigment mixture.

13. A pigment composition according to claim 12, wherein the texture improving agent is selected from the group consisting of fatty amines or fatty acids having at least 12 carbon atoms, amides, esters or salts of fatty acids and mixtures thereof, fatty alcohols or ethoxylated fatty alcohols, polyols, polyvinylalcohol, epoxidized soy bean oil, waxes, resin acids and resin acid salts.

14. A pigment composition according to claim 11, wherein the milling auxiliary is an anionic-, cationic- and nonionic-surface active agent.

15. A black pigment composition according to claim 11, wherein the anti-flocculating agent is a copper phthalocyanine, quinacridone or dihydroquinacridone derivative.

16. A pigment composition according to claim 4, wherein the pigment composition is treated with 2 to 10% by weight of quinacridone mono sulfonic acid and/or quinacridone mono sulfonic acid aluminium salt and/or 3,5-dimethyl pyrazol-1-methyl quinacridone.

17. A pigment composition according to claim 1, wherein the composition has a specific surface area in the range of 3 to 50 m²/g.

18. A method for preparing a black pigment composition comprising
a) forming a mixture by combining water; a green halogenated phthalocyanine pigment; at least one other pigment which has a reflectance of above 50%, when incorporated into a 1 mm thick PVC plate at 0.1% together with 5.0% of C.I. Pigment White 6, both by weight based on the PVC and subjected to light waves in the range of 500 to 700 nm; and optionally an additive;
b) wet-milling the mixture in a mill containing milling media at a temperature 30 to 60° C. and pH 6 to 8, for 2 to 24 hours, so as to form a suspension;
c) separating the suspension from the milling media; and
d) isolating a black co-milled pigment composition by filtration, washing and drying.

19. A method for coloring a solid or liquid substrate comprising incorporating an effective pigmenting amount of a black pigment composition according to claim 1 into said substrate.

20. A method for coloring a solid or liquid substrate comprising incorporating an effective pigmenting amount of a pigment composition according to claim 1 and an effect pigment into said substrate.

21. A method according to claim 19, wherein the high molecular weight organic material is selected from the group consisting of cellulose ethers and esters selected from the group consisting of ethyl cellulose, nitrocellulose, cellulose acetate, cellulose butyrate, aminoplasts, alkyd resins, phenolic plastics, polycarbonates, polyolefins, polystyrene, polyvinyl chloride, polyamides, polyurethanes, polyesters, rubber, casein, silicone and silicone resins, singly or in mixtures.

22. A method according to claim 21, wherein the high molecular weight organic material is an industrial or automotive paint, ink, powder or UV/EB cured coating system.

23. A method of claim 21, wherein the substrate is paper, leather, a solid or liquid polymeric material, mineral oil, an inorganic or a cosmetic material or a seed.

24. A method for coloring a substrate comprising applying a coating composition that contains an effective pigmenting amount of a pigment composition according to claim 1.

25. A method for coloring a substrate comprising applying on said substrate a coating composition that contains an effective pigmenting amount of a pigment composition according to claim 1 and an effect pigment.

26. An object made from a high molecular weight organic material pigmented with a pigment composition according to claim 1.

27. An object according to claim 26, additionally comprising an effect pigment.

28. A pigment composition according to claim 1, in which the green halogenated phthalocyanine pigment is C.I. Pigment Green 7.

29. A pigment composition according to claim 1, wherein the second pigment is an organic pigment selected from the class of pigments consisting of anthraquinone, perylene, diketopyrrolo pyrrole, iminoisoindoline, iminoisoindolinone and quinacridone pigments or a mixture thereof.

30. A pigment composition according to claim 1, wherein the second pigment is selected from the group consisting of C.I. Pigment Red 202, C.I. Pigment Red 122, C.I. Pigment Red 254, C.I. Pigment Red 255, C.I. Pigment Red 264, C.I. Pigment Red 179 and C.I. Pigment Yellow 110.
